(19) United States
(12) Patent Application Publication
(10) Pub. No.: US 2002/0113731 A1
(43) Pub. Date: Aug. 22, 2002

(54) Satellite communciation antenna array

(76) Inventor: Peter C. Strickland, Ottawa (CA)

Correspondence Address: Shapiro Cohen, Station D, P.O. Box 3440, Ottawa, ON, K1P 6P1, CA

(21) Appl. No.: 10/079,912

(22) Filed: Feb. 22, 2002

Related U.S. Application Data
(60) Provisional application No. 60/270,195, filed on Feb. 22, 2001.

(51) Int. Cl. H04B 7/185

(52) U.S. Cl. 342/354

(57) ABSTRACT

A phase scanned array of antenna elements, preferably, an array consisting of three, short, helical, radiating elements. Each antenna element is connected to a corresponding transmit/receive switch, which in turn is connected to a low-noise amplifier on the receive side of the switch. The antenna system includes receive path phase shifters which are connected to the low noise amplifiers. In a preferred embodiment, two receive path phase shifters are connected to two outer low noise amplifiers, which are in turn connected to the two outer antenna elements. The receive path phase shifters shift the phase of signals received from the two outer antenna elements. In the transmit path, two of the three transmit/receive switches are connected directly to transmit path phase shifters. According to another preferred embodiment, each of the transmit path phase shifters are connected to an outer antenna element through a corresponding transmit/receive switch. The transmit/receive switches are as usual operated in synchronism to change from transmitting to receiving operation.

This application relates to U.S. Provisional Patent Application No. 60/270,195 filed Feb. 22, 2001.

### FIELD OF INVENTION

The present invention relates to the field of antenna design and in particular to an antenna array and control circuitry for use particularly for the transmission and reception of satellite broadcasts.

### BACKGROUND OF THE INVENTION

There is a need for a small satellite communication antenna system having a high gain and a low noise temperature level. Higher gain antennas are required for new systems such as the new ICO system that is designed to handle high data rates in both the uplink and downlink directions. Conventional phased-array antennas are produced by a variety of manufacturers for satellite communications and other applications. These designs generally do not incorporate low noise amplifiers and consequently have high noise temperatures and low aperture efficiency. Other designs generally have large numbers of radiating elements and large physical size. The physical size of these antennas requires that each element in the array have phase shifters that are variable over a full 360 degrees, and such devices are quite expensive. The arrays sit on top of a conductive planes that greatly limit the ability of the antenna beam to be scanned to low elevation angles. In these antennas all, or nearly all, of the radiating elements have their own dedicated phase shifter and this results in high manufacturing cost. The dissipative losses of the phase shifters further reduce the antenna gain and also increase the antenna noise temperature substantially.

### SUMMARY OF THE INVENTION

The antenna system of the present invention includes a phase scanned array of antenna elements, preferably, an array consisting of three, short, helical, radiating elements. Each antenna element is connected to a corresponding transmit/receive switch, which in turn is connected to a low-noise amplifier on the receive side of the switch. The antenna system includes receive path phase shifters which are connected to the low noise amplifiers. In a preferred embodiment, two receive path phase shifters are connected to two outer low noise amplifiers, which are in turn connected to the two outer antenna elements. The receive path phase shifters shift the phase of signals received from the two outer antenna elements. In the transmit path, two of the three transmit/receive switches are connected directly to transmit path phase shifters. According to another preferred embodiment, each of the transmit path phase shifters are connected to an outer antenna element through a corresponding transmit/receive switch. The transmit/receive switches are as usual operated in synchronism to change from transmitting to receiving operation.

An advantage of the present antenna system is that a small number of relatively short antenna elements are utilized. Furthermore, not all the antenna elements require phase shifters and the phase shifters themselves need not vary the path phase over a range greater than 200-300 degrees much less than the 360° phase range of the prior art antenna system phase shifters. The two outer antenna elements of a three element array are phase shifted relative to the centre antenna element, thus, the centre element does not require a phase shifter. The end result is an antenna system which is compact, requiring only a few antenna elements and a printed circuit board containing the associated control components. The active array achieves a higher gain, a lower noise temperature, and higher aperture efficiency, than is possible through use of the prior art. By mounting the array vertical in relation to the fuselage of the aircraft, and in a plane parallel to the plane of the printed circuit board, the antenna can be scanned to low elevations.

In a first aspect the present invention provides an antenna array comprising three linearly arranged antenna elements, a centre element, and two outer elements, each element having substantial gain over the full upper hemisphere, transmit/receive switch means connected to each element to connect said elements to a transmitter or to a receiver, a low noise amplifier being connected to each antenna element when said transmit/receive switch connects said elements to a receiver, first phase shifting means being connected to the output of the low noise amplifiers connected to the outer elements of said array, and second phase shifting means are connected between the transmitter and the transmit/receive switch means of the outer elements.

### BRIEF DESCRIPTION OF THE DRAWINGS

The invention will now be described with reference to the drawings, in which:

FIG. 1 is a schematic illustration of the connection of the antenna system of the invention to a transceiver, and

FIG. 2 is an exploded perspective view of a complete antenna system and its protective radome.

### DETAILED DESCRIPTION OF THE PREFERRED EMBODIMENT

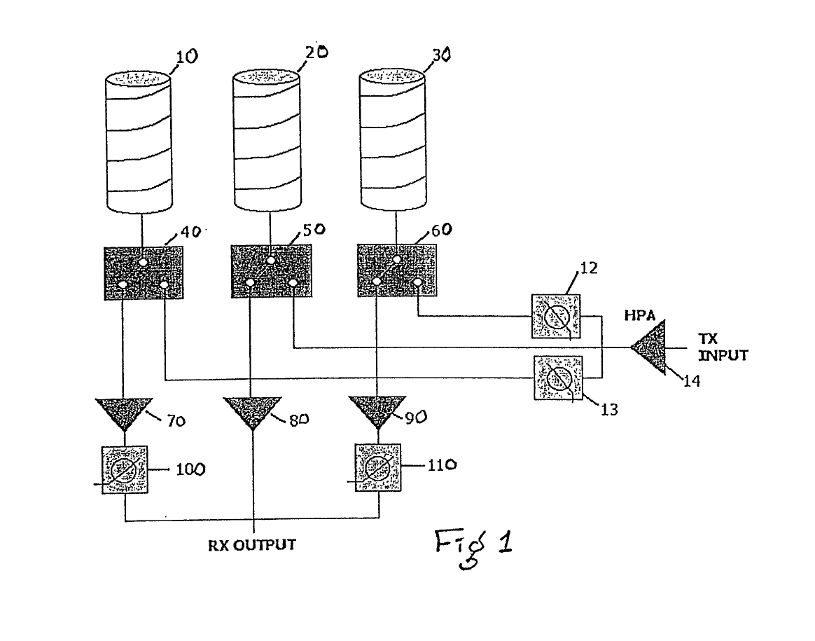

Referring to FIG. 1 there is shown an antenna system of the present invention. Three helical radiating elements 10, 20,and 30 are connected to transmit/receive switches 40, 50, and 60 respectively. In a preferred form the helical elements may be quadrafilar. The switches connect the helical elements 10, 20, and 30 to low noise amplifiers 70, 80, and 90 in receive position, and to high power amplifier 14 (HPA), and phase shifters 12 and 13 in the transmit position. The centre antenna element is connected directly through the switch 50 to the antenna element 20, the other two elements being connected through phase shifters 12 and 13. Similarly when the antenna array is used for receiving, the elements are connected through low noise amplifiers to the receiving portion of the transceiver (not shown), with phase shifters in the output of amplifiers 70 and 90, and no phase shifter in the output of the amplifier 80. The phase shifters 12,13,100, and 110 are novel in that they vary the path phase over a range of less than 300 degrees, which is less than the 360 degrees of the prior art allowing novel phase shifter technology to be used. The phase shift can be achieved by any variety of means such as varactor designs, ferrite devices, loaded line devices or switched-line devices. Power combining can be achieved using either a reactive or isolating combiner structure.

In the transmit path the transmit/receive switch inputs are excited with appropriate phases by means of two transmit path phase shifters 12 and 13. Again the centre element 20 does not require a phase shifter. A three way power divider splits the output of the high power amplifier 14 among the three transmit paths. In an alternative implementation, three HPAs are used instead of one. In this case the HPAs are at the input ports of the switches 40, 50, and 60.

The antenna of FIG. 1 is a very short active array having only three elements. Not only is it very short and has a small number of elements, but its use of phase shifters covering a range of less than 300 degrees instead of the usual 360 degrees is unique.

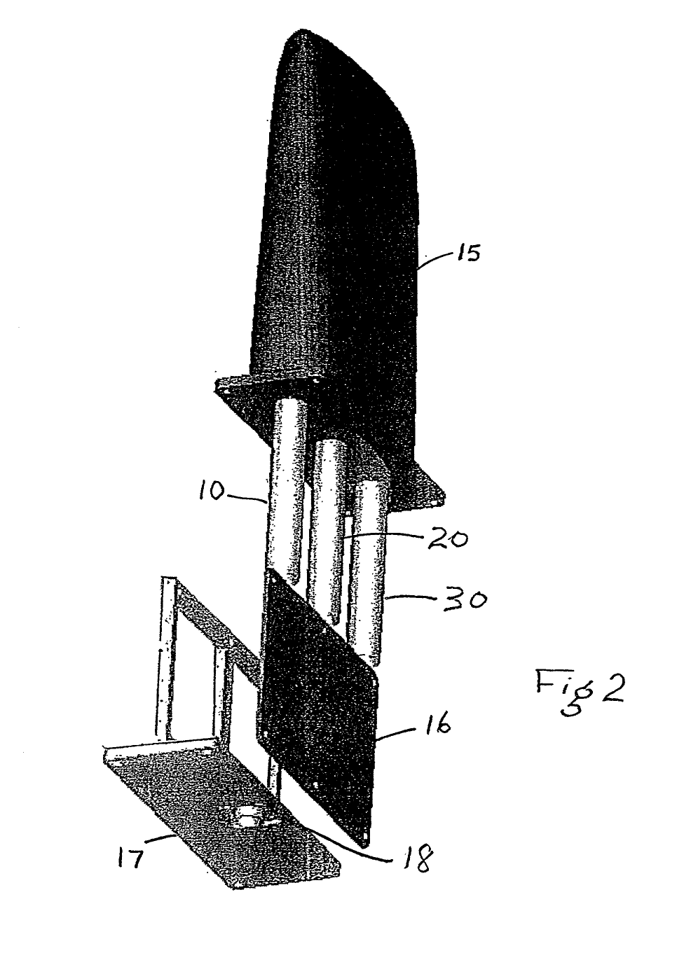

The array also achieves full upper hemisphere coverage by having the radiating elements launched off of the side of the printed circuit board (PCB) 16 instead of sitting on top of the PCB as in the prior art. As illustrated in FIG. 2 the array consists of three helical radiators 10, 20, and 30 and a PCB 16 on which the transmit/receive switches 40, 50 and 60, the low noise amplifiers 70, 80, and 90, the receive path phase shifters 100 and 110, the transmit path phase shifters 12 and 13, and the HPA 14 may be mounted. Obviously the location of the HPA 14 need not be on the PCB 16. All the antenna elements and the associated electronic circuits are housed in the radome 15, which is affixed to the base plate 17 which also carries a connector 18 for connection to an appropriate transceiver mounted in the aircraft. Each of the elements 10, 20, and 30 is connected to a transmit/receive switch which connects the element either to a low noise amplifier 40, 50, or 60, for reception or to the transmit path for transmission. An active architecture is used in reception only, not in transmission. The outputs of the low noise amplifiers are appropriately phased to produce a beam peak in the desired direction and combined to produce a single output. The receive path phasing is achieved in using only two phase shifters, one on each of the outer elements. The centre element does not require a phase shifter since the other element phases can be varied relative to it. Note that the net effect of the phase shifters is to advance the phase of one outer element relative to the phase of the centre element while delaying the phase of the other outer element. A similar effect is achieved if one of the outer elements serves as the reference, in which case two receive path phase shifters are still sufficient.

To summarize, the receive path phase shifters shift the phase of the signals received from the two outer elements such that in the direction of the desired beam peak all signals are combined in phase. Similarly, the transmit path phase shifters shift the phases of the signals that are input to the two outer elements such that, in the direction of the desired beam peak, the three transmitted signals combine in phase.

The power splitter distributes the input power to the various radiating elements in the case of transmission. In the case of reception it combines the received signals from the various elements. The power distribution may not always be uniform. For example if low sidelobes are desired then the central array elements typically receive more power than the outer elements.

I claim:

1. An antenna array comprising three linearly arranged antenna elements, a centre element, and two outer elements, each element having substantial gain over the full upper hemisphere,
transmit/receive switch means connected to each element to connect said elements to a transmitter or to a receiver,
a low noise amplifier being connected to each antenna element when said transmit/receive switch connects said elements to a receiver,
first phase shifting means being connected to the output of the low noise amplifiers connected to the outer elements of said array, and
second phase shifting means are connected between the transmitter and the transmit/receive switch means of the outer elements.

2. An antenna array as claimed in claim 1 wherein said elements are helical antennas.

3. An antenna array as claimed in claim 2 wherein said antenna array is mounted with the axes of the helical antennas orthogonal to a metallic surface.

4. An antenna array as claimed in claim 3 wherein a printed circuit board on which said transmit/receive switches and said phase shifting means are mounted, is positioned with the plane of the board parallel with the axes of the helical antennas.

5. An antenna array as claimed in claim 2 in which said helical antennas are quadrafilar.

6. An antenna array as claimed in claim 1 in which a high power amplifier is connected to a power splitter having three outputs, one output being connected directly to the central element and the other two outputs being connected to the outer elements by said phase shifting means.

7. An antenna array as claimed in claim 1 in which three high power amplifiers are provided, one high power amplifier being in the input path to each transmit/receive switch.
